(19) United States
(12) Patent Application Publication
(10) Pub. No.: US 2019/0113951 A1
(43) Pub. Date: Apr. 18, 2019

(54) SYSTEM, METHOD AND APPARATUS FOR SMART MULTIPLE DEVICES

(71) Applicant: Eternal Difference, McKinney, TX (US)

(72) Inventor: Peter Tishenko, Prosper, TX (US)

(21) Appl. No.: 16/160,217

(22) Filed: Oct. 15, 2018

Related U.S. Application Data
(60) Provisional application No. 62/572,105, filed on Oct. 13, 2017.

(51) Int. Cl. G06F 1/16; H04M 1/02; G06F 1/18; B60R 11/02; B60K 35/00

(52) U.S. Cl. CPC G06F 1/1632; H04M 1/0202; G06F 1/182; B60R 2011/0003; B60R 11/0241; B60K 35/00; G06F 1/189

(57) ABSTRACT

Hardware and software mobile and stationary combination of MGNs (Mobile-Go-Networks), combining cell phones and all smart electronics, in communication with and share each other's functions through hardware and software solutions, including methods to prevent unwanted camera and audio snooping through unwanted phone malware. The MGNs can exist as single all-in-one MGNs that can (also) connect with much larger MGNs.

### CROSS REFERENCE TO RELATED PATENT APPLICATION

The present application is a non-provisional and claims the benefit of U.S. Provisional Patent Application Ser. No. 62/572,105, filed Oct. 13, 2017, entitled “Cell Phone Security and Multi-Utility Mobile Station (Go-Station),” the disclosure of which is incorporated herein by reference.

### BACKGROUND OF THE PRESENT INVENTION

### Background

The rise of smartphones and the emerging Internet of Things (IoT) have created considerable capabilities for interconnections between a wide variety of electronic devices, the intricacies of which are only now being considered.

Relating to the novel implementations/combinations of mobile cell phones, computing, charging, projecting, HUD (Head-up-Display), all smart electronics connecting, plus camera-microphone security through multi communication-connection networks for home and (also) on the go by connecting anywhere to Mobile-go-Networks or MGNs.

The present invention relates to smart electronic communication network packages. The network packages consist of various complexities with upgradeable options through various hardware, networks and all types of software (including applications) that integrate and communicate together to provide multi-functional phone-computing-projection-HUD-touch screen-peripheral capabilities within a group of connected smart electronics packages. These packages include features for camera and microphone (audible) security. The instant invention includes all novel software required for any and all devices to operate, as described within any MGN environment, including cell phones.

Cell phones and smart cameras, by themselves, are susceptible to malware that violate user privacy by allowing for others to turn on the cameras and microphone(s) at inopportune times to invade the user and others privacy. In addition, in order to maintain the small size of cell phones, despite growing capabilities, they are limited in computing power and screen size. An increase of computing power and/or screen size negatively affects phone battery life, and (also) requires larger package size. All of these factors contribute to a physically larger and heavier cell phone, which the users do not want. The purpose of the present invention is to allow the cell phone to be what it physically is today, but also to provide for it to be easily inserted/removed and/or communicate through, when desired, a larger-mobile or stationary MGN, and used anywhere as described herein.

### SUMMARY OF THE PRESENT INVENTION

According to various exemplary embodiments, Smart electronic devices, such as cell phones, peripherals, computing devices, desk-work stations, projectors, TVs, head-up-displays (HUD), smart monitors, etc. are well documented in existing art. Traditionally, these are essentially separate independent devices. In addition, not all are completely mobile or easily mobile. Also, unwanted cell phone malware are present day issues with snooping by turning on cameras and/or the microphone at inopportune times. Sometimes during private occasions and/or in privacy situations/areas, this has become an increasing problem. Depending upon packaging, these features can become even more of an issue, but new types of packaging and/or software can provide extra security while being transported in the air, on the ground, in a bathroom/bedroom or anywhere else. The MGN can provide this with the expanded MGN network phone-computer-projection (etc.) capabilities. In addition, this patent provides for expanded phone functions with larger screens without increasing the size of traditional cell phones.

The above and other features of these embodiments relating to the invention, including various novel details of construction and combinations of parts, are more particularly described with reference to the accompanying drawings and pointed out in the claims. The particular assemblies are shown by way of illustration only and not as a limitation of the claims. The principles and features of this invention may be employed in various and numerous embodiments without departing from the scope of the invention.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is an illustrative all-way communication network configuration that illustrates some features of the present invention, particularly in a home environment;

FIG. 2 is another illustrative all-way communication network configuration that illustrates some features of the present invention, particularly in a home environment with remote capabilities;

FIG. 3 an illustrative all-way communication network configuration that illustrates some features of the present invention, particularly in a vehicular or moving environment;

FIG. 4 is an exemplary apparatus that implements features of the present invention in an embodiment thereof; and

FIG. 5 is another view of the exemplary apparatus of FIG. 4 that implements features of the present invention in an embodiment thereof.

### DETAILED DESCRIPTION OF THE PRESENT INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the exemplary embodiments of the invention (used for the ‘Detailed Description’) is defined only by the appended claims.

In accordance with various embodiments, the components, process steps, and/or data structures incorporated therein may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a field programmable gate array (FPGA) or other related component.

This invention is in the field of electronics and software. Relating to the novel implementation/combinations of mobile cell phones, computing, charging, projecting, HUD (Head-up-Display), all smart electronics connecting, plus camera-microphone security through multi communication-connection networks for home and (also) on the go by connecting anywhere to MGNs.

The invention particularly relates to smart electronic communication network packages, as illustrated in detail hereinbelow. The network packages consist of various complexities with upgradeable options through various hardware, networks and all types of software (including applications) that integrate and communicate together to provide multi-functional phone-computing-projection-HUD-touch screen-peripheral capabilities within a group of connected smart electronics packages. These packages include features for camera and microphone (audible) security.

The instant invention includes software required for any and all devices to operate as described within any MGN environment, including cell phones. Cell phones and smart cameras, by themselves, are susceptible to malware that violate user privacy by allowing for others to turn on the cameras and microphone(s) at inopportune times to invade the user and others privacy. In addition, in order to maintain the small size of cell phones, despite growing capabilities, they are limited in computing power and screen size. An increase of computing power and/or screen size negatively affects phone battery life, and (also) requires larger package size. All contribute to a physically larger and heavier cell phone, which the users do not want. The purpose of this invention is to allow the cell phone to be what it physically is today, but also to provide for it to be easily inserted/removed and/or communicate through, when desired, a larger-mobile or stationary MGN, and used anywhere as described herein.

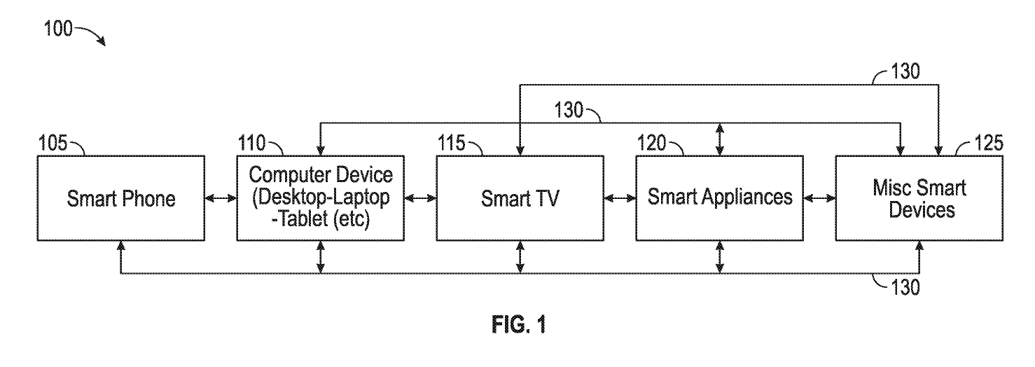

With reference now to FIG. 1 of the DRAWINGS, there is illustrated an exemplary all-way communication network, generally designated by the reference numeral 100, which may be employed in the home. As shown in FIG. 1, a smartphone 105 is interconnected in network 100 either wirelessly and/or through wireline or hardware methods. Also shown is a computer, generally designated by the reference numeral 110, which it should be understood could be a desktop PC, a laptop, a tablet or other computing equipment. Within the home, another interconnectivity component could be a Smart TV, generally designated by the reference numeral 115, various smart appliances, such as a refrigerator, generally designated by the reference numeral 120, and miscellaneous other smart devices, generally designated by the reference numeral 125.

As discussed, the interconnections between the various devices can be wireless or wireline, e.g., through various wireline links, generally designated by the reference numeral 130, which can form intercommunications between all of the components or only between some of them.

Again, with the rise of IoT devices, which have increasingly more powerful computer processors therein, it is now possible to share or use all or part of the capabilities of any device. For example, smartphone 105 can share or use the computing capability of the PC 110, the smart TX 115, smart appliances 120 and/or other smart devices 125. Conversely, the aforementioned PC 110, the smart TX 115, smart appliances 120 and/or other smart devices 125 can interface with and operate as a phone 105. Thus, a user of the PC 110 can place calls, answer calls, receive texts, etc. through this interconnectivity, e.g., using wireless signals or the aforedescribed wireline links 130.

It should, of course, be understood that respective software and other interface protocols will be required to enable this interconnectivity.

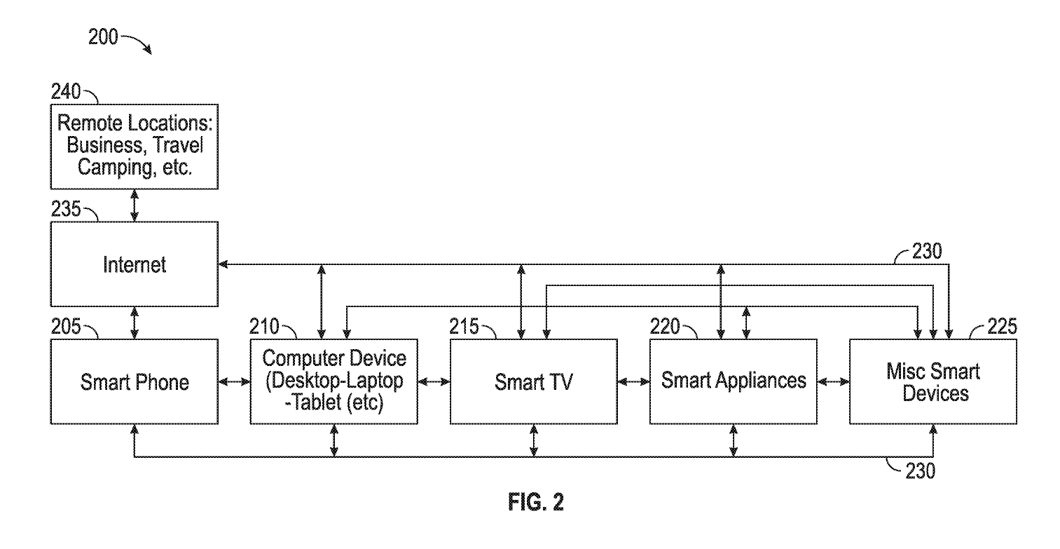

With reference now to FIG. 2 of the DRAWINGS, there is shown a further variant of the exemplary all-way communication network for the home, generally designated by the reference numeral 200. As shown, smartphone 205, computer 210, Smart TV 215, smart appliances 220 and other smart devices 225 are interconnected through various wireline links, generally designated by the reference numeral 230. As discussed, wireless communications are also envisioned.

As also shown in FIG. 2, remote capabilities are included in this embodiment, e.g., through an Internet port, generally designated by the reference numeral 235, which then connects the aforesaid devices to remote locations, generally designated by the reference numeral 240, which can include work or business, vacation or travel spots, camping, and other remote areas. It should thus be clear that the interconnectivity options in this embodiment are far larger than in the home-only embodiment. For example, while out on a fishing trip, a user may need to use their cell or smart phone 205 to access their home (or other) computer 210, and then run that computer on the smart phone 205 (or another device so interconnected).

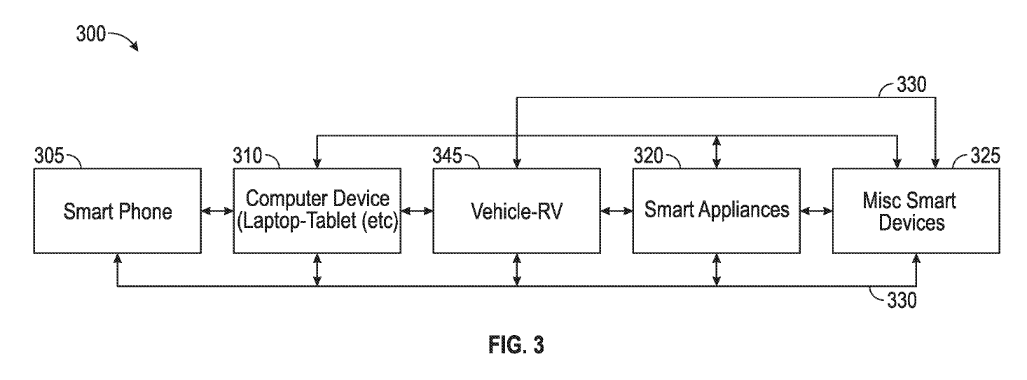

Referring now to FIG. 3 of the DRAWINGS, there is illustrated another embodiment of the present invention, generally designated by the reference numeral 300, which is directed to usages in a moving vehicle, generally designated by the reference numeral 345, such as a recreational vehicle. It should be understood that this embodiment, just as the earlier ones, accomplishes the aforedescribed two-way and shared communications and computing, just as in the home. In this embodiment, a vehicle's processing capabilities and its monitor and/or heads up display can, through interconnections with the smart phone 305, display map driving instructions and/or operate as a phone, as described. Furthermore, the phone 305, perhaps through the computer 310, can provide projection capability and information to the vehicle's heads up display.

With reference again to FIG. 3 of the DRAWINGS, the numerous two-way and shared interconnections between the components can be accomplished wirelessly or though wireline or hardware connections 330. It should be understood that, to enable this interconnectivity, all of the devices preferably have some combination of system software and/or other software applications to make the two-way communications possible. Also, with computers 310 involved, master-slave protocols are needed so that the computer 310 can model-operate as if it were the smart phone 305 and access the phone's internal files and Apps, as well as share or use computing capability of the phone through software or software Apps. For security, all smart devices within the network 300 include a security feature, such as a password, to keep hackers at bay.

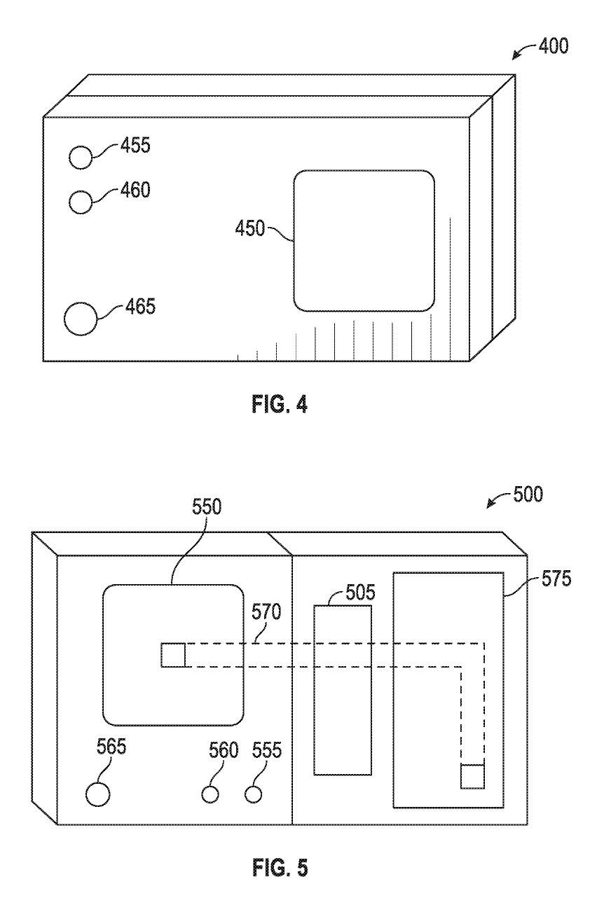

With reference now to FIG. 4 of the DRAWINGS, there is illustrated another embodiment of the present invention, generally designated by the reference numeral 400, which is representative of an all-in-one MGN configuration of the present invention. In particular, the security enclosure or black box 400 offers an advance in cell phone privacy, as also shown in FIG. 5. A touch screen 450, speaker 455, microphone 460 and emergency button 465 are shown in this external view of the box 400.

With reference now to FIG. 5 of the DRAWINGS, there is illustrated the configuration shown in FIG. 4 opened up, generally designated by the reference numeral 500. As shown, a cell or smart phone 505 is placed in the box 400 for security purposes. Also shown is a touchscreen 550, an interface cable 570, and an interface board 575. Not shown are various wireline connectors between the components and the interface board 575. As discussed, wireline connectivity extends from within the enclosure or cavity so formed by top and bottom portions of the enclosure, which when attached electronically seals the enclosed components, along with other protections such as from water. As indicated, secure Internet 235 and remote capabilities 240 are provided from the interior or cavity to the outside.

As shown in the FIGURES, particularly FIGS. 4 and 5, described in detail hereinabove, the instant invention is directed to embodiments of a single easily “mobile” cell phone play-office-workstation (Go-Station), with various features. These features include improvements in battery backup and/or charging, larger touch screens 450/550, i.e., larger than the that of the cell phones within the enclosure, and more. The aforementioned boxes or security enclosures 400/500 can further constitute enclosures with internal computing devices, besides the connected cell phone (i.e., more powerful computing devices, such as Tablets, Laptops, Projectors, routers, peripherals, etc.), as described hereinabove

The enclosure 400/500 can be a separate container with all of the features and/or hardware added, or it can be a larger cell phone-tablet-laptop-computing device that allows for the smaller phone/phone device to be plugged directly inside (like a DVD, SD card, etc.). Alternatively, the enclosure 400/500 can be connected externally with cabling; the larger phone-tablet-laptop-computing device with the software applications, mentioned herein, now performs all the cell phone functions (e.g., the enclosure's touch screen 450/550 takes the place of the cell phone's touch screen, the enclosure's computing device's speaker 455 and microphone 460 take the place of the cell phone's speaker and microphone, etc.), plus it has the larger screen and more powerful computing capability with or without the phone being connected.

With further reference to FIGS. 4 and 5, external communications to-from the mobile enclosure 400/500 are by wireless and/or wired to separate desktops, laptops, tablets, monitor/TVs, networks, routers, speakers & microphones, touchpads, keyboards, mouse, peripherals, etc. As mentioned above, these devices 400/500 perform as the enclosed cell phone would perform through the software applications that are employed in the various interfaces.

It should be understood that projectors and/or HUD capability can be included in different versions of this mobile Go-Station.

It should also be understood that different Go-Stations may include peripheral features to internally and/or externally communicate through the newly-developed software connectivity applications, such as but not limited to Touchpad/mouse/keyboard technologies. As noted, communications can be through wireless and wired features, including networks, routers, Bluetooth, and other interconnectivity means.

In further embodiments of the present invention, as described, additional touch/press buttons and tabs with predefined and user defined features that may include items, such as one touch emergency dialing 465, that can contain prerecorded messages and/or text and/or current GPS location, as is understood in the art.

The instant invention preferably includes multiple connectivity ports (USB, HDMI, speaker-microphone, Ethernet, etc.) in the embodiments.

It should also be understood that although the embodiments shown provide for one smart or cell phone in the enclosures 400/500, two or more phones are contemplated as well, with the discreet interconnectivities provided for each.

With reference to the requisite new software applications for the communications interconnectivity, needed are to-from and/or mirroring type software applications amongst all devices, and all possible combinations, including standard programmed items and user defined programs. The new applications/software, herein, depending upon purchased package type and the included hardware (internal and external) for proper connectivity and/or communication to all devices, including the different cell phones.

The smart or cell phones described herein have camera and audio security provided, but not limited to: cell phone camera and audio security, when connected through a cable to the Go-Station, using external hardware such as a physical camera cover and dummy audio plug; cell phone camera & audio security when installed into a Go-Station enclosure; cell phone camera, audio, and memory security through a manual switch located on the cell phone (a phone (only) standalone solution); and provisions for the prevention of unwanted snooping.

The following description covers several preferred modes for the implementation of the features of the present invention, as described hereinabove and shown in the Drawings.

As discussed, the instant invention also addresses the development of multiple “mobile” case/enclosures, for inserting cell phones, which can have different performance features for various user needs. Case sizes, while being able to be easily hand carried, may vary from about 3″×6″×0.25″ to (perhaps) 8″×12″×2″ or slightly larger. The case/enclosure 400/500 may be a separate item that other hardware, such as Tablets, Laptops, cell phones, etc., can easily be inserted into and removed as desired, or the case/enclosure can actually be the Tablet, Laptop, etc., that is slightly larger than normal to accommodate a cell phone therein which could be inserted into the unit like a SD Card or DVD.

In either of the several package types described herein, the mobile-single package concept with camera & audio security is preserved, and the package doubles as both a cell phone & computer-office-workstation (Go-Station). In a 2 or 3 part solution, the cell phone can be separate from something like a laptop and be connected to the laptop when desired through (just) cabling. The newly-developed software interconnectivity applications, described herein, would still be required to have the laptop mimic the cell phone, and it would be a bit clumsy to use when sitting on the couch or driving down the road, but this is (also) a packaging option.

The Basic (single) Package, another embodiment of the present invention, allows for an enclosure 400/500 or other hardware that covers all cell cameras (front and back), and provides either a hardware dummy microphone plug, silencer, white noise generator, or scrambler to eliminate viruses from enabling both cameras & audio for unwanted/snooping purposes. Both the camera and audio may be turned off through a manual switch, such as a battery disconnect (e.g., can remove power from the main phone interfaces and operations, without losing memory and set-up types of items). In some cases, a sound proof enclosure may be preferred. In addition, charging capability, at a minimum would be included. Just use preferred phone camera and audio disable feature, connect charging cable to the provided access port and an outlet nearby. If there isn't a nearby outlet, some versions can carry a battery that will provide extended life and charge the phone, until the battery needs recharging. Pull the cell cover(s) and audio silencer off/out when the phone is needed. It should be noted that in this package, covers & plugs may be preferred instead of a case/enclosure. The camera covers may be any style, and could be part of a new phone protection case and/or a simple addition for the after-market.

In another embodiment of the present invention, a Mid-range (single) Package, in addition to the Basic Package items, can include a rechargeable battery for extended operational use and charging, when an AC or other external outlet is not available. In addition, this package can include a much larger built-in touch screen for normal phone operation by providing either a wireless and/or wired connection to the cell phone inserted inside or nearby. The phone cameras can still be completely covered, while inside the enclosure or with one of the other methods, but when in or connected to the Go-Station the cell phone can be disconnected and operated as normal if desired, or be connected to the Go-Station where the larger Go-Station touch screen makes it easier to read and type when texting (etc.). Extra buttons can be added for one touch emergency dialing, with a prescripted verbal and/or texted message, sent to family member phones and other chosen phone numbers, and may/may not include GPS location.

Extra buttons can either be pre-programmed and/or provide standard one touch functions for items like HUD/driving directions, answering the phone, quick access to messages and/or emails, website connections, as well as other user defined needs. This upgrade may/may not have additional computing power and items such as a network, router, touch screen Tablet-Laptop-other Computing Device and/or peripherals like touchpad/mouse/keyboard in providing additional convenience and capability/features. This upgrade may/may not require an interface card for activities between all devices like the cell phone, touch screen, touch screen Tablet-Laptop-Computing Devices-Projectors, network, router, peripherals, etc. Includes a cell phone software application to provide Tablet or Laptop or Computing device communication, as well as other software applications to provide seamless control and communications between all devices. At this package level and higher, this single and mobile Go-Station becomes the cell phone and much more, including the addition of buttons to devices and device to device communication. The Go-Station can be used as a fully operational cell phone, when the cell phone is connected to it, and provide for security from phone viruses turning on cameras and/or audio. The Go-Station can perform these things from anywhere in the house/building/car/plane/etc.

In addition, the Go-Station, with the larger touch screen and/or computing device, which may (also) be insertable & removable like the phone, now doubles as a single unit that is both a mobile phone & computer-office-workstation (Go-Station).

In still another embodiment, there is provided a High-End Package, in addition to containing features of the prior two packages discussed (Basic & Mid-range), this upgrade requires similar software applications for cell phone and other device communications. With the removable, or not, internal computing device (Laptop, Tablet, etc.), this package provides for a complete mobile phone-workstation capability with/without the easily removable cell phone all in one device. When only the phone is needed, just remove the cell phone and it is ready as always. The Go-Station will function similarly to the normal Tablet or Laptop device depending upon devices installed in the Go-Station. When the user wants the extra features, just re-install the phone and use the phone features now provided from the Go-Station, including driving directions and/or accessing the HUD-driving direction feature. When the user needs it for on-the-go presentations or meetings, while out of the office, just insert the phone into the case and use the projector feature or mirror/wire to a larger monitor and use the Go-Station peripherals. The high-end package includes projection capability, higher definition touch screens, more peripherals and computing power. The Go-Station, with the larger touch screen and/or computer device, that may (also) be insertable & removable like the phone, now doubles as a single and mobile phone & computer-office-workstation (Go-Station).

It will be understood that many additional changes in the details, materials, steps and arrangement of parts, which have been herein described and illustrated in order to explain the nature of the invention, may be made by those skilled in the art within the principle and scope of the invention as expressed in the appended claims.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims (or as described above).

What is claimed is:

1. A smart phone security enclosure, said security enclosure comprising:
a top and a bottom portion, said top and bottom portions being detachable, a cavity being formed within said security enclosure when said top and bottom portions are attached, said smart phone secured therein;
a plurality of communications interconnectors, said communications interconnectors connecting audio and visual components of said smart phone to corresponding components of said security enclosure;
a screen atop said top portion of said security enclosure, said screen being connected to said smart phone and said plurality of communications interconnectors and
a battery, said battery being connected to power said smart phone within said security enclosure.

2. The security enclosure according to claim 1, wherein said battery is rechargeable.

3. The security enclosure according to claim 1, wherein said screen is a touchscreen.

4. The security enclosure according to claim 1, further comprising:
an emergency button.

5. The security enclosure according to claim 4, wherein said emergency button, when initiated, transmits a verbal and/or text message to a family member of a user.

6. A computing device containing a security enclosure comprising:
a slot, said slot capable of securely receiving a smart phone therein; and
a plurality of communications interconnectors, said communications interconnectors connecting components of said smart phone to corresponding components of said computing device,
whereby a user of said smart phone connects to the CPU of said computing device and functionalities thereof using the smart phone.

7. The computing device according to claim 6, wherein said slot further comprises an internal tray to receive and cover said smart phone.

8. The computing device according to claim 6, wherein said smart phone adjusts a monitor attached to said computing device.

9. The computing device according to claim 8, wherein said smart phone accesses projection systems of said computing device and provides information thereto,
whereby said information from said smart phone is displayed on said monitor.

10. A vehicle containing a security enclosure comprising:
a slot, said slot capable of securely receiving a smart phone therein; and
a plurality of communications interconnectors, said communications interconnectors connecting components of said smart phone to corresponding components of said vehicle,
whereby a user of said smart phone connects to the functionalities of said vehicle using the smart phone.

11. The vehicle according to claim 10, wherein said slot further comprises an internal tray to receive and cover said smart phone.

12. The vehicle according to claim 10, wherein said smart phone adjusts a monitor of said vehicle.

13. The vehicle of claim 12, wherein said smart phone accesses projection systems of said vehicle, providing heads-up-display information.

14. The vehicle according to claim 13, wherein map information is provided from said smart phone to said projection system, said projection system employing said map information to the driver on the heads-up display of the vehicle.
